(19) United States
(12) Patent Application Publication
(10) Pub. No.: US 2010/0206396 A1
(43) Pub. Date: Aug. 19, 2010

(54) CONSTRUCTIONAL UNIT AND FRESH AIR SYSTEM

(76) Inventors: John Ronald Mammarella, Windsor (CA); John Francis Marentette, Tecumseh (CA); James Kenneth Vanderveen, Blenheim (CA); Ki-Ho Lee, Windsor (CA); Zhouxuan Xia, Windsor (CA); Stephen Edgar Brackett, Clarkston, MI (US); Pau M. Arnold, Lasalle (CA)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/595,399

(22) PCT Filed: Apr. 9, 2008
(86) PCT No.: PCT/EP08/54276

§ 371 Date: Mar. 19, 2010

Related U.S. Application Data
(60) Provisional application No. 60/910,885, filed on Apr. 10, 2007.

(51) Int. Cl. F02B 77/00

(52) U.S. Cl. 137/315.03

(57) ABSTRACT

The invention relates to a pre-assembled constructional unit (1) of a fresh air system (2) for an internal combustion engine, especially of a motor vehicle. Said constructional unit comprises an electrical unit (3) having respective coils (5) for a plurality of cylinders of the internal combustion engine for actuating a fuel injection valve, said electrical unit having an electric wiring (6) for actuating the coils (5), a plurality of parallel insertion openings (10) that extend coaxially through the coils (5), and a plastic element (9) that is injection-molded on the coils (5) and the wiring (6). The constructional unit further comprises a fuel unit (4) having respective tubular connecting pieces (12) for every coil (5) for receiving a respective injection valve and a distributor housing (13) that contains a fuel distributing compartment (14) on which the parallel connecting pieces (12) are arranged and that has connecting openings (15) which interconnect the distributing compartment (14) to the interior of the connecting pieces (12) so as to communicate therewith, the fuel unit (4) and the electrical unit (3) being mounted to each other in such a manner that the connecting pieces (12) are coaxially inserted in the insertion openings (10).

The present invention relates to a pre-assemblable constructional unit of a fresh air system for an internal combustion engine, in particular of a motor vehicle. The invention furthermore relates to a fresh air system equipped with at least one such constructional unit.

Internal combustion engines, in particular in motor vehicles, have a fresh air system that, as a rule, has a distribution chamber from which lead individual fresh air canals to combustion chambers of cylinders of the internal combustion engine. Furthermore, modern internal combustion engines have a fuel injection assembly that inject fuel, by means of injection nozzles, directly into the combustion chambers of the cylinder or into the previously-mentioned fresh air canals that lead to the combustion chambers. Electrical cabling is required to actuate the injection valves or injection nozzles, which electrical cabling comprises the power supply lines and/or signal lines for controlling or for operating electric coils and the like. The assembly of internal combustion engine is comparably expensive, in particular when individual components are intended to be accessible or easily de-assembled for maintenance purposes.

The present invention addresses the problem of demonstrating a way for a simplified construction of an internal combustion engine that is characterised by an economical manufacturability and/or simple maintenance.

This problem is solved by the subject matter of the independent claims. Advantageous embodiments are the subject matter of the dependent claims.

The invention is based on the general concept of equipping a fresh air system for an internal combustion engine with a separately manufacturable, pre-assemblable constructional unit that comprises both an electrical unit as well as a fuel unit. The electrical unit has an electric coil for each of the plurality of cylinders of the internal combustion engine in order to actuate a fuel injection valve. Furthermore, the electrical unit comprises an electrical cabling for actuating the coils. It has a plurality of insertion openings that are oriented parallel to one another that respectively penetrate the coils coaxially. Moreover, the electrical unit has a plastic body that is injection moulded onto the coils and onto the cabling. In contrast thereto, the fuel unit has a tubular connecting piece associated with each coil for receiving an injection valve. Furthermore, the fuel unit comprises a distributor housing that contains a fuel distribution chamber that has connection openings and to which the connecting pieces are welded or soldered in such a manner that they are directed toward one another in a parallel fashion and are furthermore connected to the distributor chamber in a communicating manner. Moreover, the fuel unit and the electrical unit are coordinated with one another in such a manner that for the purposes of assembly, the connecting pieces of the fuel unit can be coaxially inserted into the insertion openings of the electrical unit. By means of the suggested method of construction, both the electric components are combined into the electrical unit, while the fuel components are assembled into the fuel unit. By means of the connecting pieces and the insertion openings, the units, which are respectively independent of one another and are separately pre-assemblable, can be combined into a constructional unit that then comprises the electric components and the fuel components and that is furthermore completely pre-assemblable independent of the fresh air system. By the targeted grouping and assembling of different components of the internal combustion engine, the assembly process can be simplified as a whole.

An embodiment, which is particularly advantageous, is one in which the electrical unit has a tubular body for each coil, said tubular body being arranged coaxially to each respective coil, and said tubular body, when in the assembled state, furthermore protrudes with one end section of the plastic body on one side facing away from the fuel unit, and finally said tubular body forms a section of the associated insertion opening. Advantageously, the connecting pieces are dimensioned in such a manner that in the assembled state, they extend through the respective insertion opening and, in particular, protrude over the end section of the respective tubular body. This special method of construction makes if possible for no sealings to be required between the fuel unit and the electrical unit or between the individual connecting pieces and the corresponding insertion openings since the fuel arrives directly into the respective injection chamber from the connecting pieces by means of the injection valves inserted into the connecting pieces, the constructional unit and, in particular, the electrical unit being installed on said injection chamber. In the assembled state, thus only one sealing is required between the electrical unit and a housing of the fresh air system or between the protruding end sections of the tubular bodies and the housing of the fresh air system in the region of the fuel injection openings. In this manner, a sufficient sealing can be realised with reduced expenditure, which sealing particularly prevents an emission of fuel into the surroundings of the internal combustion engine.

Additional important features and advantages of the invention can be found in the dependent claims, in the drawings, and in the pertinent description of the figures with reference to the drawings.

It is understood that the features described above and those to be described in what follows can be used not only in the particular cited combination; but also in other combinations or independently without departing from the scope of the present invention.

Preferred embodiments of the invention are shown in the drawings and are described in more detail in the following description, the same reference numerals referring to components which are the same or functionally the same or similar.

It is schematically shown in

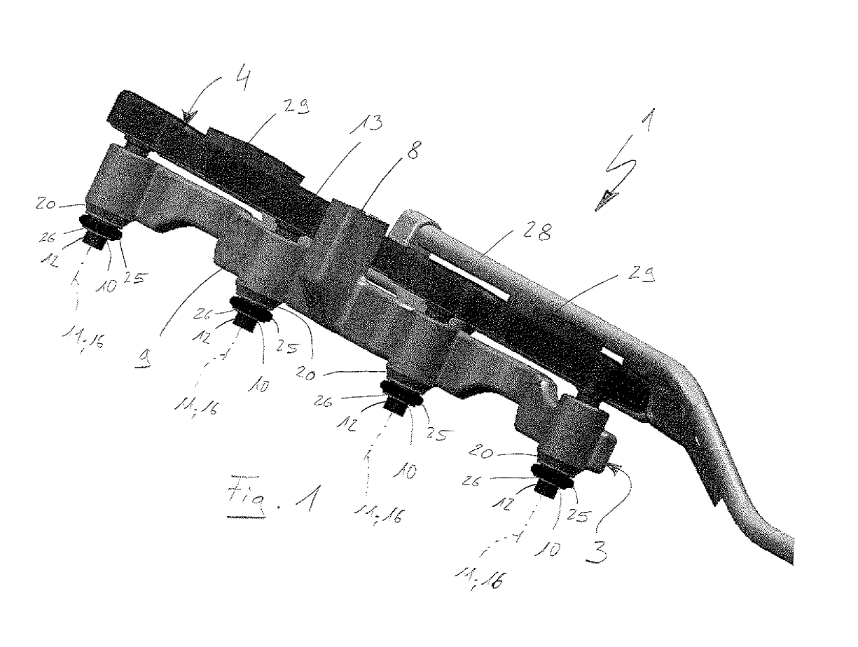

FIG. 1 a perspective view of a pre-assembled constructional unit,

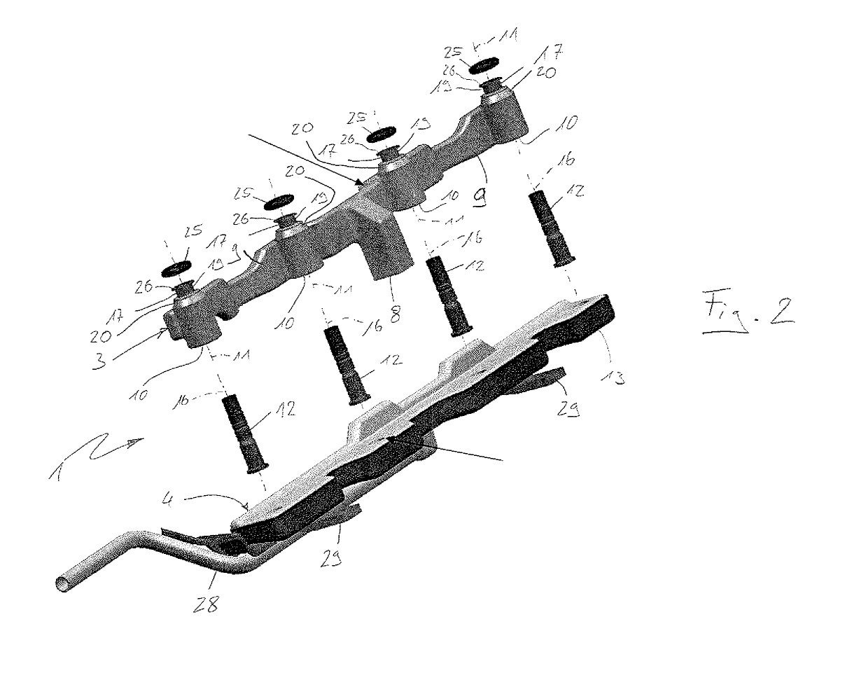

FIG. 2 a perspective view of the constructional unit in an exploded view,

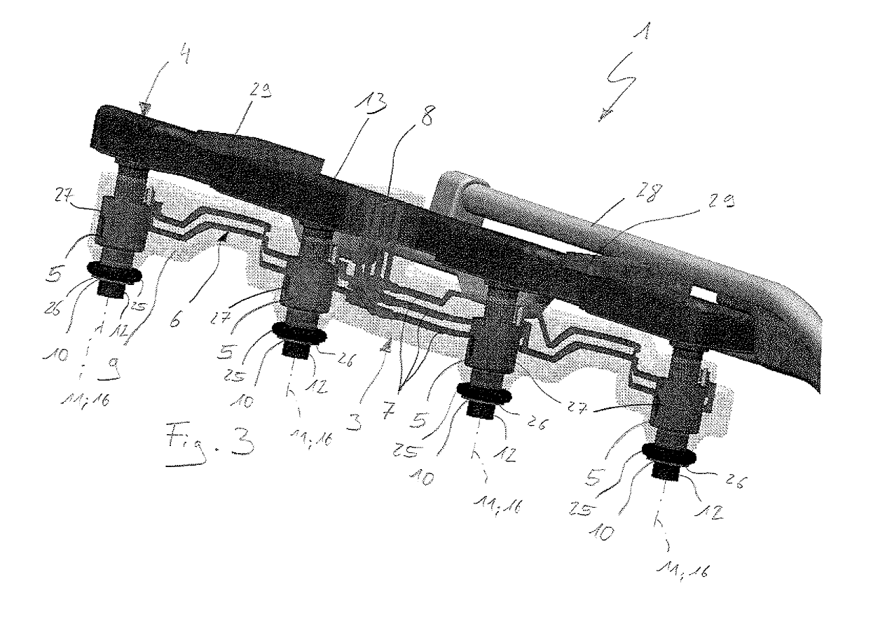

FIG. 3 a perspective view as in FIG. 1, however with a transparent plastic body,

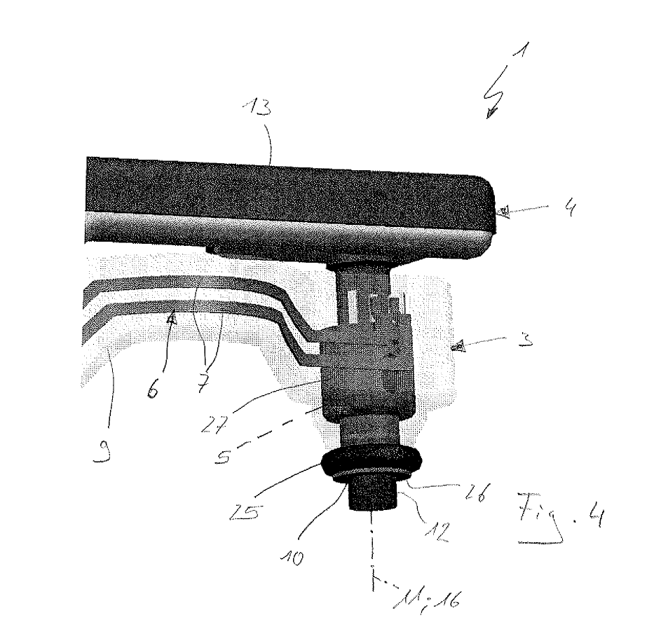

FIG. 4 an enlarged detail view in the region of a coil in the transparent plastic body,

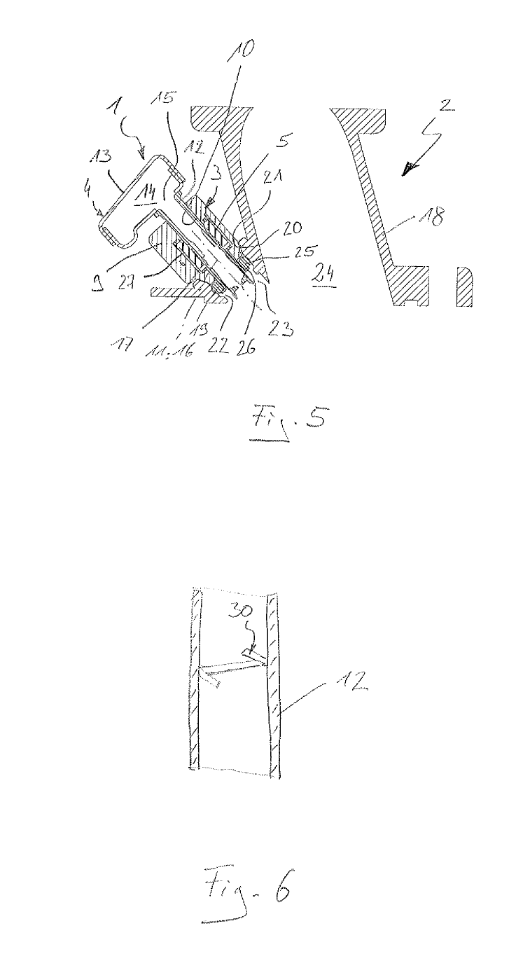

FIG. 5 a simplified cross section of a fresh air system in the region of a constructional unit attached thereon,

FIG. 6 a very simplified longitudinal section through a connecting piece in a preferred embodiment.

Corresponding to FIGS. 1 to 5, a pre-assemblable constructional unit 1 comprises a fresh air system 2 of an internal combustion engine, which fresh air system is partially shown in FIG. 5, that can particularly be located in a motor vehicle, said pre-assemblable constructional unit 1 furthermore comprising an electrical unit 3 and a fuel unit 4. The constructional unit 1 is entirely pre-assemblable and can, according to FIG. 5, be attached on the fresh air system 2. With regard to the fresh air system 2, said constructional unit forms a separately manufacturable unit.

For a plurality of cylinders of the internal combustion engine that are not shown here, the electrical unit 3 has respective electric coils 5 by means of which a fuel injection valve, which is not shown here, can respectively be activated. In the example, the electrical unit 3 comprises four coils 5. However, this number is random and results from the number of cylinders. The electrical unit 3 furthermore comprises an electrical cabling 6, by means of which the coils 5 can be actuated. The cabling 6 comprises for this purpose a plurality of lines 7 and advantageously a shared electric plug and socket connection 8. The electrical unit is moreover equipped with a plastic body 9, which is represented as transparent in FIGS. 3 and 4, in order to be able to be able to better present the components of the electrical unit 3 that are housed or embedded therein. The plastic body 9 is injection moulded onto the cabling 6. All coils 5 and all lines 7 are, in particular, thereby completely enclosed by the plastic of the plastic body 9, in particular the plug and socket connection 8 is as well, with the exception of a plug side. The electrical unit 3 additionally comprises an insertion opening 10, which is coaxial to each coil 5, and that furthermore coaxially crosses the respective coils 5. Furthermore, the longitudinal central axes 11 of the insertion openings 10 are arranged parallel to one another or are oriented parallel to one another.

The fuel unit 4 has a tubular connecting piece 12 for each coil 5, said connecting piece being configured to respectively receive an injection valve. The fuel unit 4 furthermore has a distributor housing 13 that contains or encloses a fuel distribution chamber 14 that is recognisable in the cross sectional representation of FIG. 5. The distributor housing 13 comprises for each connecting piece 12 a connection opening 15. Furthermore, the connecting pieces 12 are attached directly on the distributor housing 13, each in the region of one of the connection openings, in particular by means of welding or soldering. The connecting pieces 12 can also be adhered onto the distributor housing 13 or can be integrally configured therewith, in particular in the instance of a manufacturing out of plastic. The connecting pieces 12 are directed parallely relative to one another. Their longitudinal central axes 16 thus extend parallel to one another. In the inserted state, the longitudinal central axes 11 of the insertion openings 10 coincide with the longitudinal central axes 16 of the connecting pieces 12.

In the assembled state that is a recognisable in FIGS. 1 and 3 to 5, the fuel unit 4 and the electrical unit 3 are assembled on each other in such a manner that the connecting pieces 12 are each coaxially inserted into the insertion openings 10. Preferably, the electrical unit 3 has for each coil 5 furthermore at least one tubular body 17. Said tubular body is coaxially arranged with respect to the respective coil 5 and, in the assembled state, protrudes with an end section 19 from the plastic body 9 on a side facing away from the fuel unit 4 or on a side facing a housing 18 of the fresh air system 2. In this manner, the respective tubular body 17 forms a section of the respective insertion opening 10. The connecting pieces 12 are now, in particular with regard to their axial length, dimensioned in such a manner that they extend into the end section 19 of the tubular body 17 in the assembled state. In the embodiment shown, the connecting pieces 12 extend through the respective insertion opening 10 and even axially protrude over the end section 19 of the respective tubular body 17.

The electrical unit 3 moreover comprises seat regions 20 integrally formed on or configured on the plastic body 9. Said seat regions are respectively arranged coaxially to one of the insertion openings 10. If, as is shown in FIG. 5, the electrical unit 3 or the constructional unit 1 is attached on the housing 18 of the fresh air system 2, seat regions 20 respectively co-operate with a counter seat region 21, which is shaped complementarily thereto and is furthermore configured on the housing 18. The respective counter seat region 21 comprises respectively a fuel injection opening 22 that in the example passes into a fresh air canal 24 of the housing 18 or of the fresh air system 2 by means of a fuel injection canal 23. In this manner, with the injection valve inserted in the respective connecting piece 12, fuel can arrive directly in the injection canal 23 from the fuel valve or from the associated connecting piece 12 without the fuel coming into contact with a component of the electrical unit 3.

The tubular bodies 17 of the electrical unit 3 can, corresponding to the preferred embodiment shown here, be respectively arranged coaxially to one of the seat regions 20. Furthermore, they carry on their protruding end section a ring sealing 25. For example, the respective end section 19 can be equipped with a radially protruding, circumferential flange 26. The respective ring sealing 25 in the assembled state dips into the counter seat region 21 and effects there a radial sealing between the injection canal 23 and the end section 19. In this manner, both an intake of unmetered air and an emission of fuel can be prevented.

In the embodiment shown here, the tubular body 17 is respectively configured in such a manner that it has a supporting section 27, which is arranged in the interior of the plastic body 9 and which encloses the respective coil 5. At the same time, electrical connections can be configured on this supporting section 27, said electrical connections electrically contacting coils 5 that are arranged in the interior of the supporting section 27 and furthermore electrically contacting lines 7 running outside the supporting section 27.

Corresponding to FIGS. 1 to 3, the fuel unit 4 is furthermore equipped with a supply tube 28 that is attached on the distributor housing 13. In particular, the supply tube 28 is welded or soldered onto the distributor housing 13. The supply tube 28 is thus communicatingly connected to the distributor chamber 14. In particular, the supply tube 28 leads to a fuel pump.

The constructional unit 1 can, for example, be attached to the housing 18 of the exhaust gas system 2 by means of webs 29. For example, these webs 29 have through-openings that make it possible for the constructional unit 1 to be screw-connected on the housing 18. In the shown preferred example, the webs 29 are attached to the fuel unit 4, and namely preferably on its distributor housing 13, being welded or soldered thereon, for example. It is notable that the electrical unit 3 rests solidly on the housing exclusively by means of a plug and socket connection, however it is not directly attached thereto. Furthermore, the fuel unit 4 rests solidly on the electrical unit 3 by means of a plug and socket connection, however is not directly attached thereto. A fastening of the fuel unit 4 on the housing 18 is achieved by means of the webs 29 by means of which a fastening of the fuel unit 4 onto the electrical unit 3 as well as a fastening of the electrical unit 3 onto the housing 18 is also indirectly realised.

The connecting pieces 12 can, corresponding to FIG. 6, contain a locking mechanism 30 that is configured in such a manner that an injection nozzle, which is inserted axially into the connecting piece 12, locks therein once an adequate insertion depth has been reached. The injection nozzle locked on the locking mechanism is then axially secured in the connecting piece 12. That is to say, the respective injection nozzle can then be readily axially removed out of the connecting piece 12. In this manner, a simplified assembly for the constructional unit 1 equipped with the injection nozzles can be achieved. For example, the injection nozzles can thus be inserted into the associated connecting pieces 12 prior to the installation of the constructional unit 1 on the housing 18. By means of the locking mechanism 30, the injection nozzles are held firmly in place in the connecting pieces 12. In order to be able to remove an injection nozzle out of the respective connecting piece 12, for example for the purposes of maintenance, the locking mechanism 30 can be configured in particular in such a manner that the locked-in injection nozzle can be released again from the connecting piece 12 by means of turning. For this purpose, the locking mechanism 30 can have, for example, a screw-shaped contour.

1. A pre-assemblable constructional unit of a fresh air system for an internal combustion engine, comprising:
an electrical unit,
a plurality of cylinders of the internal combustion engine,
at least one electric coil for actuating a fuel injection valve,
an electric cabling for actuating the coil,
a plurality of insertion openings that are oriented generally parallel to one another and that coaxially pass through one of the coils, wherein the insertion opening has a plastic body that is injection moulded on the coils and the cabling, and
a fuel unit that, has a tubular connecting piece for receiving an injection valve, having a distributor housing that contains a fuel distributor chamber on which is arranged connecting pieces, wherein the connecting pieces are directed generally parallel to one another, having connection openings by means of which the distributor chamber is in communication with the interior of the connecting pieces, and
wherein the fuel unit and the electrical unit are positioned with respect to each other such that the connecting pieces are coaxially inserted into the insertion openings.

2. The constructional unit as specified in claim 1, wherein the connecting pieces are at least one of welded and soldered onto the distributor housing.

3. The constructional unit as specified in claim 1, wherein the electrical unit has a tubular body, said tubular body being arranged coaxially to the coil, and protruding with an end section extending from the plastic body on a side facing away from the fuel unit in an assembled state, and forming a section on the associated insertion opening, wherein the connecting pieces are dimensioned such that, they extend into the end section of the tubular body, wherein the connecting pieces extend through, the respective insertion opening and, protrude over the end section of the respective tubular body.

4. The constructional unit as specified in claim 1, wherein the electrical unit includes at least one seat region integrally moulded on the plastic body, said seat region is arranged coaxially to one of the insertion openings, wherein upon installing the constructional unit on a housing of a fresh air system, the electrical unit cooperates with at least one counter seat region that enclose a fuel injection opening.

5. The constructional unit as specified in claim 3, wherein the tubular bodies are arranged coaxially to one of the seat regions and support a ring seal on the end sections, said ring seal, in the assembled state, extends into the counter seat region and respectively radially sealing a fuel injection canal, which has the respective injection opening, from the end section.

6. The constructional unit as specified in claim 3, wherein the tubular bodies comprise a support section enclosing the coils.

7. The constructional unit as specified in claim 1, wherein the cabling has a shared electric plug and socket connection that is moulded by the plastic of the plastic body, wherein the coils can be actuated.

8. The constructional unit as specified in claim 1, wherein the fuel unit has a supply tube that is attached on the distributor housing, by welding or soldering, and that furthermore is communicatingly connected to the distributor chamber.

9. The constructional unit as specified in claim 1, wherein at least one of the connecting pieces contains a locking mechanism that, upon axial insertion of the respective injection nozzle, locks into place and axially secures the injection nozzle in the connecting piece, wherein the locking mechanism can be configured, such that the injection nozzle that is locked into place can be unsecured again for removal out of the connecting piece by means of turning.

10. A fresh air system for an internal combustion engine comprising:
a housing having at least one fresh air canal for a plurality of cylinders of the internal combustion engine, said fresh air canal leading to a combustion chamber of the cylinder, and leading into the fuel injection canal,
wherein at least one pre-assemblable constructional unit, connecting pieces is in communication, in the assembled state, with one of the injection canals.

11. The constructional unit as specified in claim 2, wherein the electrical unit has a tubular body, said tubular body being arranged coaxially to the coil, and protruding with an end section extending from the plastic body on a side facing away from the fuel unit in an assembled state, and a section on the associated insertion opening is formed, wherein the connecting pieces are dimensioned such that, they extend into the end section of the tubular body, wherein the connecting pieces extend through, the respective insertion opening and, protrude over the end section of the respective tubular body.

12. The constructional unit as specified in claim 2, wherein the electrical unit includes a seat region integrally moulded on the plastic body, said seat region is arranged coaxially to one of the insertion openings, wherein upon installing the constructional unit on a housing of a fresh air system, the electrical unit seat region cooperates with a counter seat region that enclose a fuel injection opening.

13. The constructional unit as specified in claim 3, wherein the electrical unit includes a seat region integrally moulded on the plastic body, said seat region is arranged coaxially to one of the insertion openings, wherein upon installing the constructional unit on a housing of a fresh air system, the electrical unit seat region cooperates with a counter seat region that enclose a fuel injection opening.

14. The constructional unit as specified in the claim 4, wherein the tubular bodies are arranged coaxially to one of the seat regions and support a ring seal on the end sections, said ring seal, in the assembled state, extends into the counter seat region and respectively radially sealing a fuel injection canal, which has the respective injection opening, from the end section.

15. The constructional unit as specified in claim 4, wherein the tubular bodies comprise a support section enclosing the coils.

16. The constructional unit as specified in claim 5, wherein the tubular bodies comprise a support section enclosing the coils.
